(19) United States
(12) Patent Application Publication
(10) Pub. No.: US 2022/0403946 A1
(43) Pub. Date: Dec. 22, 2022

(54) ACTUATOR HOUSING FOR A COOLANT CIRCUIT OF A MOTOR VEHICLE

(71) Applicant: ILLINOIS TOOL WORKS INC., Glenview, IL (US)

(72) Inventors: Rolf HABERMANN, Bergen (DE); Maximilian GÜNTHER, Hanover (DE)

(21) Appl. No.: 17/843,734

(22) Filed: Jun. 17, 2022

(30) Foreign Application Priority Data
Jun. 22, 2021 (DE) DE 102021116129.0
Jun. 2, 2022 (DE) DE 102022114002.4

(51) Int. Cl. F16K 27/06; F16K 5/06

(52) U.S. Cl. CPC F16K 27/067; F16K 5/0647

(57) ABSTRACT

An actuator housing for a valve apparatus for a coolant circuit of a motor vehicle includes an actuator housing part for receiving at least one actuator component. The actuator housing also includes a valve housing part for at least partially limiting and hydraulically sealing a region of a valve device to be hydraulically sealed.

### TECHNICAL FIELD

The present invention relates to an actuator housing for a coolant circuit of a motor vehicle, as well as a valve apparatus for a coolant circuit of a motor vehicle having such an actuator housing.

### BACKGROUND

A valve is a component for shutting off or controlling the flow of fluids (liquids or gases).

In valves, a closure part (e.g., closure body or shut-off body such as a plate, cone, ball, or needle) is usually moved approximately parallel to the direction of flow or about an axis of rotation transverse to the direction of flow of the fluid. The flow is interrupted in that the closure part is pressed with the sealing surface to a suitably shaped opening, the valve or sealing seat.

In addition to shutting off material flows, valves are well-suited for control tasks.

A ball valve is understood to mean a valve in which the sealing action is produced by a moving ball. In its typical use as a check valve, the ball prevents the return flow of fluid through the valve.

Ball valves can be used as actively controlled or regulated valves. Here, a spherical shut-off body is actively actuated or rotated by an actuator. In the case of a ball valve, the shut-off body performs a rotational movement in order to open or close one or more flow cross-sections.

DE 10 2018 117 240 A1 describes a coolant valve for a vehicle, comprising a housing having a plurality of coolant ports and a valve element that is arranged adjustably within the housing for connecting or disconnecting coolant ports, as well as at least one sealing arrangement arranged in the region of at least one coolant port, which abuts sealingly against the housing on the one hand and against the valve element on the other hand, wherein the sealing arrangement comprises a carrier element made of a first material and a sealing element made of a second material, wherein the second material is softer than the first material, wherein the sealing element comprises a first sealing lip abutting against the valve element and the carrier element comprises a support portion, wherein the first sealing lip protrudes with a free end over the support portion, and wherein the first sealing lip is pressed against the support portion during a flow of coolant through the coolant valve.

Such coolant valves are used in cooling circuits of vehicles, such as cars or trucks. They are used, for example, in order to cool an internal combustion engine. Depending on the position of the valve element, for example, cooling liquid is passed by a radiator via a bypass line during a warmup phase of the internal combustion engine and, after reaching the operating temperature, passed through the radiator. In the case of coolant valves, depending on the application, it is also possible for coolant to flow only temporarily through the coolant valve, for example when the coolant flow is completely prevented during the cold start phase of a combustion engine. Control of the valve element can be self-actuated, for example via elements made of expanding materials. However, electric drives for adjusting the valve element are also possible, which are controlled by a control device.

A compensating tank or cooling fluid compensating tank is a fitting that is used in small and large systems, in particular in motor vehicles having internal combustion engines. It is needed in order to compensate for its loss due to temperature-related expansion, evaporation, or vaporization of a liquid or gaseous operating means; in the case of temperature expansion, the fluctuating volume is compensated. Usually, the system pressure is maintained by means of the compensating tank and the provided operating means.

Actors, also known as actuators, usually refer to drive-technical components, which, for example, convert an electrical signal (commands issued by a control computer) into mechanical movements or changes in physical quantities such as pressure or temperature and thereby actively intervene in the controlled process.

In valve devices, for example a thermostat valve for a cooling fluid circuit of a motor vehicle, the fluid ports or the inlets and outlets are arranged directly in a valve housing. An actuator or actuating drive, preferably with a corresponding transmission, is arranged in a separate housing and is then connected to the valve housing.

### SUMMARY

The problem of the present invention is to provide an actuator housing and a valve apparatus having such an actuator housing for a coolant circuit of a motor vehicle that provides an alternative to apparatuses known from the prior art.

A further problem of the present invention is to provide an actuator housing and a valve apparatus having such an actuator housing that require a small amount of space.

In addition, it is a problem of the present invention to provide an actuator housing as well as a valve apparatus having such an actuator housing that is simply constructed and simply to assemble or manufacture.

According to the invention, an actuator housing for a valve apparatus for a coolant circuit of a motor vehicle is provided. It comprises an actuator housing part for receiving at least one actuator component. The present invention is characterized in that the actuator housing also comprises a valve housing part for at least partially limiting and hydraulically sealing a region of a valve device to be hydraulically sealed.

The hydraulic sealing is carried out between a corresponding first connection or sealing surface of the actuator housing and a corresponding second connection or sealing surface of the valve apparatus.

It is thus provided according to the invention that the actuator housing comprises a valve housing part in order to form a region or portion of a valve device. This region can comprise, in whole or in part, a valve body, one or more fluid ports, and/or a valve seat.

In this way, a corresponding valve device is not formed to be completely hydraulically sealed in order to attach a separate actuator to the hydraulically sealed valve device; rather, the valve housing part of the actuator housing is directly connected to the valve device and thereby spatially and preferably sealingly limits a region of the valve device.

A corresponding connection between the valve housing part and the valve device, in particular of a valve housing, is preferably configured as a hydraulically sealed connection.

In this way, a valve apparatus that claims a significantly smaller design space can be provided. At the same time, the assembly or connection of the valve housing part of the actuator housing to the valve device also takes up less space, requires fewer individual parts or components, and also requires fewer assembly steps.

The valve housing part of the actuator housing can comprise the first connecting surface for connecting to a valve device.

The valve housing part is preferably at least a partial region of a valve housing and/or a valve seat and/or a fluid port and thus, upon connection to a corresponding region of a valve device, at least partially or completely forms a hydraulically closed valve housing and/or a valve seat and/or a fluid port of the valve device.

Due to the fact that the valve housing and/or valve seat and/or fluid port are at least partially integrated into the actuator housing, the need for design space is significantly less. In this way, for example, fluid ports such as an inlet and/or outlet can be integrated into the actuator housing.

Accordingly, the region of a valve device to be hydraulically sealed can be, or can comprise, at least a partial region of a valve housing and/or a valve seat and/or a fluid port.

The valve housing part can be connectable in a hydraulically sealing manner to the region of a valve device to be hydraulically sealed by means of a positively locking and/or a non-positively locking and/or a materially locking connection.

When providing a positively locking and/or a non-positively locking connection, e.g., a screw, clip, or snap-fit connection, a corresponding sealing device can be provided for hydraulic sealing.

In the case of a materially locking connection, for example by means of welding, gluing, or soldering, a separate sealing device is generally not necessary. A materially locking connection is therefore advantageous in this regard.

The actuator component can be configured as an actuating drive and/or a transmission arranged in the actuator housing.

Furthermore, a connecting device can be provided that is configured to connect the actuator component to an actuating element of a shut-off body of a valve device in a positively locking and/or non-positively locking manner, wherein the actuating element is preferably a shaft.

Via the connecting device, the actuating drive or actuator of a valve apparatus can be connected directly, or even indirectly via a transmission, to the actuating element of the shut-off body of the valve device in a simple and reliable manner, for example by plugging.

The connecting device is preferably configured as a non-rotating structure in order to transfer a corresponding torque from the actuator to the actuating element of the shut-off body. The actuating element accordingly comprises a correspondingly configured connecting device.

Furthermore, a through-opening for passing an actuating element of at least one shut-off body of the valve apparatus can be provided between the actuator housing part and the valve housing part in order to connect the actuating element to an actuator.

The through-opening can be hydraulically sealed against the actuating element by means of a corresponding sealing device, for example.

The actuating element can be arranged in the fluid port, such that an annular opening is provided between the fluid port and the actuating element, for example. In this way, a fluid can flow into the valve device via the fluid port.

The actuator housing part can be integrally connected to the valve housing part.

Preferably, the actuator housing can be manufactured by means of an injection molding process in a single injection molding operation, such that both the actuator housing part and the valve housing part are formed integrally from the same material.

According to a further aspect of the present invention, a valve apparatus for a coolant circuit of a motor vehicle is provided. It comprises a valve device having at least one shut-off body and at least two fluid ports and an actuator housing described above, wherein a first connecting surface of the valve housing part of the actuator housing is connected in hydraulically sealing manner to a second connecting surface of a region of the valve device to be hydraulically sealed.

The advantages described above using the actuator housing for a coolant circuit of a motor vehicle apply analogously to the valve apparatus for a coolant circuit of a motor vehicle having such an actuator housing.

In particular, in the case of such a valve apparatus for a coolant circuit of a motor vehicle, it is advantageous that it requires fewer components, can be manufactured in fewer work steps, and requires a smaller design space, not only in the assembled state but also during assembly. The valve apparatus can be a thermostat valve of a cooling fluid circuit of a motor vehicle, and in particular a ball valve.

The valve apparatus for a coolant circuit of a motor vehicle according to the present invention can preferably be a coolant valve that is provided for a vehicle, such as a car or truck. The coolant valve can be arranged in a cooling circuit of a vehicle having an internal combustion engine or an electric motor or a hybrid vehicle. For example, it can be provided for cooling an internal combustion engine or batteries of an electric vehicle. The coolant valve can be a thermostat valve. An electric drive can be provided for adjusting the valve element, said drive being controlled by a control device of the vehicle.

However, it is also possible that a temperature-dependent control element is provided, for example an element made of expanding material, which changes its length depending on the temperature and thereby adjusts the valve element or the closure body. The housing or housing device of the coolant valve has two or more than two coolant or fluid ports, which can be connected to, for example, coolant lines of a cooling circuit of a vehicle.

For example, by adjusting the valve element, two coolant ports can be connected to or disconnected from one another. For example, if the housing has three coolant ports, by adjusting the valve element, for example, coolant supplied to one of the coolant ports can be supplied to either a first or a second of the two other coolant ports.

For example, the two other coolant ports can be connected to a radiator on the one hand and to a bypass line on the other hand in order to bypass the radiator. It is also possible that, during operation of the coolant valve, coolant cannot flow through the cooling circuit and thus through the coolant valve at times, for example during a cold start phase of an internal combustion engine. A cooling liquid, such as cooling water, is in particular considered as the coolant here.

However, the valve apparatus according to the invention is transferable to virtually all customary valves.

In the context of the present invention, a valve apparatus can be a component for shutting off or controlling the flow of fluids (liquids or gases) such as a corner valve, a through-way valve, or a directional control valve, which can be configured as (electric) motor-operated valves with or without a valve drive.

With the valve device, a fluid can thus be impeded while flowing in both directions (flow valves), or, depending on the direction of flow (check valves), the fluid can be impeded by the pressure (pressure valves), or the flow can be controlled simultaneously on multiple lines (directional valves, 3/2 or higher).

The valve apparatus can be a lock valve or flow valve, such as a throttle valve, a retarding valve, a change valve (OR element), a two-pressure valve (AND element), a quick-release valve, a through-way valve, a flow switch valve, a 2/2-way valve, or a check valve (throttle check valve, quick-vent valve, KFR [combined freeflow valve with integrated backflow preventer]) or a pressure valve (pressure-limiting valve and sequence valve, pressure balance (differential pressure valve), pressure-reducing valve, pressure control valve) or a directional control valve (three-way valves, four-way valves, or higher order directional valves).

With respect to closure types, a differentiation must be made between seat valves and spool valves. The sealing body moves either in the axis of flow or perpendicular thereto, i.e., towards the sealing surface (seat) or along it (spool). The valve apparatus can be configured as a poppet valve (seat valve), pipe valve, or a double seat valve (seat valve), plunger valve (spool valve), roller diaphragm valve, pinch valve, needle valve (seat valve), and preferably as a ball valve (optionally seat or spool valve).

According to a further aspect of the present invention, there is provided a method for manufacturing a valve apparatus for a coolant circuit of a motor vehicle, wherein a valve housing part of an actuator housing described above is connected in a hydraulically sealing manner to a region of a valve device to be hydraulically sealed, such that a valve housing and/or a fluid connector and/or a valve seat is preferably formed by connecting the valve housing part to the valve device.

The actuator housing can comprise a first connecting surface via which the valve housing part is connected in a hydraulically sealing manner to a second connecting surface of the region of the valve device to be hydraulically sealed.

The connection is preferably produced by welding, in particular by plastic welding.

The actuator housing can comprise the first connecting surface and the valve apparatus can comprise the second connecting surface, wherein the corresponding contours in the connecting surfaces form weld contours that are arranged in such a way that the welding takes place in one direction and preferably in one welding operation.

The actuator housing and/or the valve apparatus can be manufactured from plastic by means of a single-component or multi-component injection molding process.

The actuator housing and/or the valve apparatus are manufactured from plastic by means of a single-component or multi-component injection molding process.

### BRIEF DESCRIPTION OF THE DRAWINGS

The present invention will now be described in more detail on the basis of an exemplary embodiment shown in the figures. The figures show:

FIG. 1 is a laterally cut, regional view of an actuator housing according to the invention and a valve device of a valve apparatus,

FIG. 2 is a further laterally cut view of the actuator housing of the valve apparatus,

FIG. 3 is a further laterally cut view of the actuator housing, and

FIG. 4 is a further laterally cut view of the actuator housing and the valve device of the valve apparatus.

### DETAILED DESCRIPTION

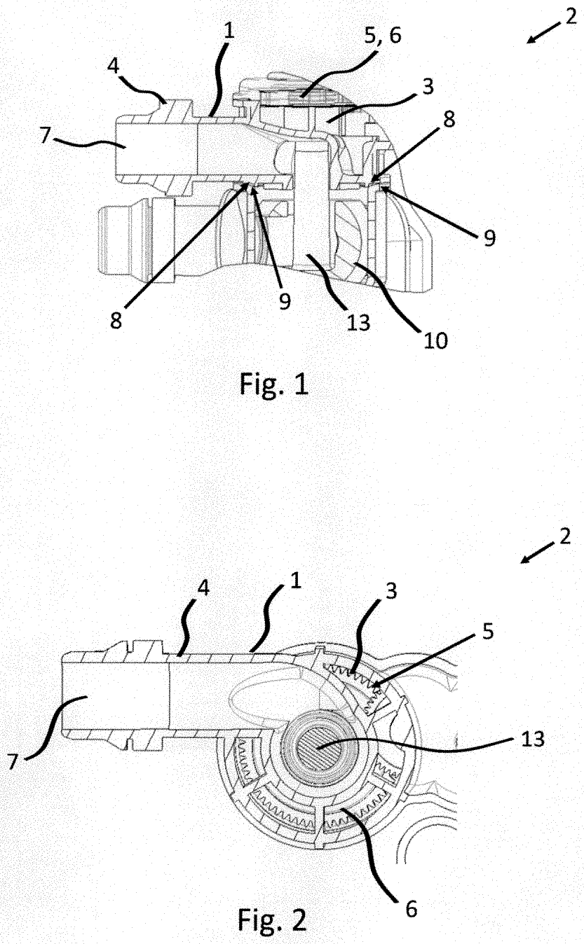

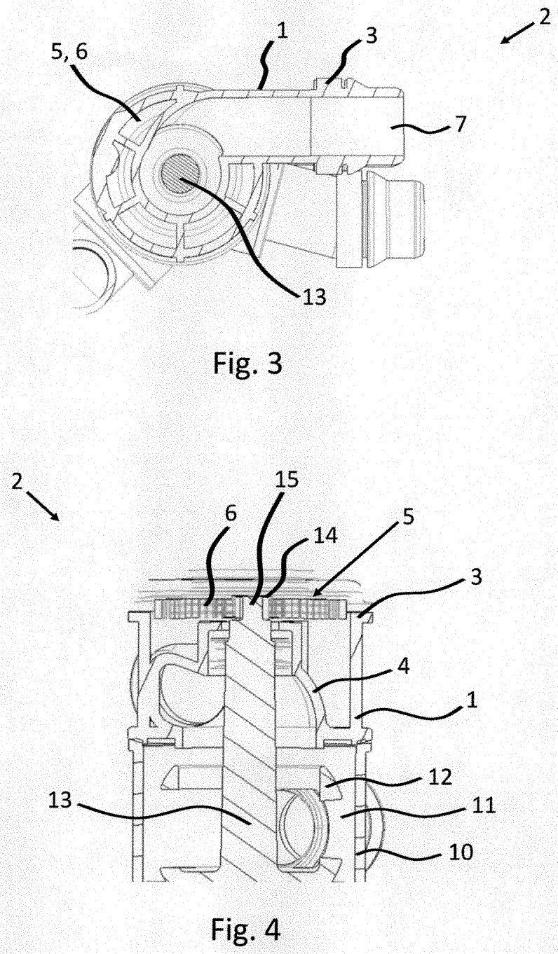

In the following, an actuator housing 1 for a coolant circuit of a motor vehicle and a valve apparatus 2 for a coolant circuit of a motor vehicle having such an actuator housing are described on the basis of an exemplary embodiment (FIGS. 1 to 4).

In this exemplary embodiment, the present invention is provided in a thermostat valve 10 of a cooling fluid circuit of a motor vehicle, wherein the thermostat valve is configured as a ball valve.

The actuator housing 1 comprises an actuator housing part 3 and a valve housing part 4.

According to the present exemplary embodiment, a drive or an actuating drive (not shown) is arranged in the actuator housing part 3 for actuating a valve device 5 of the valve apparatus 2.

Furthermore, the actuating drive is connected via a transmission 5 to corresponding transmission stages or gears 6, which are also arranged in the actuator housing part 3.

According to the present exemplary embodiment, the valve housing part 4 forms a fluid port 7 and a coolant inlet, respectively. The fluid port 7 with a corresponding through-opening is thus an integral component of the valve housing part 4 of the actuator housing 1. Additionally, and/or alternatively, the valve housing part can form, regionally or entirely, one or more of the actuator components described at the outset, such as a valve housing and/or one or more fluid ports 7 and/or a valve seat.

A first connecting surface 8 is also provided on the valve housing part 4, via which surface the actuator housing 1 can be connected to a correspondingly configured second connecting surface 9 of a valve device 10 of the valve apparatus 2.

The first connecting surface 8 is connected in a hydraulically sealing manner to the second connecting surface 9 by means of welding.

According to the present exemplary embodiment, the fluid port 7 opens into a valve seat 11 of the valve device 10, in which a shut-off body 12 and a closure element are arranged. The shut-off body is spherical or spherically segmented in configuration.

The shut-off body 12 can be actuated via a corresponding actuating element 13; in the present embodiment, a corresponding shaft.

The transmission 5 comprises a first connecting device 14, via which the actuating drive [is connectable] to the actuating element 13 of the valve device 10, which comprises a correspondingly configured connecting device 15, such that corresponding movements of the drive via the transmission 5 as well as the first and second connecting device 14, 15 are transferable to the actuating element 13 and thus to the shut-off body 12, in order to open or close the valve or actuate the shut-off body 12 accordingly in order to release or close the fluid port 7.

A through-opening for passing the actuating element 13 of the valve apparatus 2 is provided between the actuator housing part 3 and the valve housing part 4 in order to connect the actuating element 13 to an actuator or drive.

Accordingly, the valve apparatus 2 comprises the valve device 10 as well as the actuator housing 1 together with the components described above (at least one shut-off body 12 and at least two fluid ports 7).

The actuating drive and the transmission 5 as well as the gears 6 are referred to as actuator components.

Furthermore, according to the present invention, a method is provided for manufacturing a valve apparatus 2 for a coolant circuit of a motor vehicle, wherein a valve housing part 4 of an actuator housing 1 is connected in a hydraulically sealing manner via a first connecting surface 8 and a second connecting surface 9 to a region of the valve device 2 [sic: 10] to be hydraulically sealed.

By connecting the valve housing part to the valve device, one or more fluid ports 7 and/or one or more valve seats can be formed.

As already described above, the actuator housing 1 comprises a first connecting surface 8 via which the valve housing part is connected in a hydraulically sealing manner to a second connecting surface 9 of the valve device to be hydraulically sealed.

The actuator housing and/or the valve apparatus are manufactured from plastic by means of a single-component or multi-component injection molding process.

List of reference numerals

| | |
|---|---|
| 1 | Actuator housing |
| 2 | Valve apparatus |
| 3 | Actuator housing part |
| 4 | Valve housing part |
| 5 | Transmission |
| 6 | Gear |
| 7 | Fluid port |
| 8 | First connecting surface |
| 9 | Second connecting surface |
| 10 | Valve device |
| 11 | Valve seat |
| 12 | Shut-off body |
| 13 | Actuating element |
| 14 | First connecting device |
| 15 | Second connecting device |

1. An actuator housing for a valve apparatus for a coolant circuit of a motor vehicle, comprising:
an actuator housing part for receiving at least one actuator component,
a valve housing part for at least partially limiting and hydraulically sealing a region of a valve device to be hydraulically sealed.

2. The actuator housing according to claim 1, wherein
the valve housing part comprises a first connecting surface for connecting with a valve device.

3. The actuator housing (1) according to claim 1, wherein
the valve housing part is at least a partial region of a valve housing and/or a valve seat and/or a fluid port.

4. The actuator housing according to claim 1, wherein
the region of a valve device to be hydraulically sealed is at least a partial region of a valve housing and/or a valve seat and/or a fluid port (7).

5. The actuator housing according to claim 1, wherein
the valve housing part is connectable in a hydraulically sealing manner to the region of a valve device to be hydraulically sealed by means of a positively locking and/or a non-positively locking and/or a materially locking connection.

6. The actuator housing according to claim 1, wherein
the actuator component is an actuating drive and/or a transmission (5) arranged in the actuator housing (1), wherein a connecting device is provided for connecting the actuator component to an actuating element (13) of a shut-off body (12) of a valve device (10) in a positively and/or non-positively locking manner, wherein the actuating element (13) is a shaft.

7. The actuator housing according to claim 1, wherein
a through-opening for passing an actuating element of at least one shut-off body of the valve apparatus is provided between the actuator housing part and the valve housing part in order to connect the actuating element to an actuator.

8. A valve apparatus for a coolant circuit of a motor vehicle, comprising:
a valve device having at least one shut-off body and at least two fluid ports, and
an actuator housing according to claim 1, wherein a valve housing part of the actuator housing is connected by a first connecting surface in a hydraulically sealing manner to a second connecting surface of a region of the valve device to be hydraulically sealed.

9. The valve apparatus according to claim 8, wherein
the valve apparatus is a thermostat ball valve of a cooling fluid circuit of a motor vehicle.

10. A method for manufacturing a valve apparatus for a coolant circuit of a motor vehicle, wherein a valve housing part of an actuator housing according to claim 1 is connected in a hydraulically sealing manner to a region of a valve device to be hydraulically sealed, such that a fluid port and/or a valve seat is formed by connecting the valve housing part to the valve device.
